(19) United States
(12) Patent Application Publication
(10) Pub. No.: US 2012/0266105 A1
(43) Pub. Date: Oct. 18, 2012

(54) SYSTEM AND METHOD FOR ASSOCIATING EVENTS WITH OBJECTS IN ELECTRONIC DEVICE

(75) Inventor: JUN LI, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/415,857

(22) Filed: Mar. 9, 2012

(30) Foreign Application Priority Data
Apr. 14, 2011 (CN) 201110093404.6

(51) Int. Cl. G06F 3/048

(52) U.S. Cl. 715/810

(57) ABSTRACT

An electronic device includes a plurality of objects. The plurality of objects include short message service (SMS) messages, pictures, music, and videos. The electronic device allows user-selected associations between one or more events and a particular user-selected operation behavior of an object. When the selected operation behavior of the object is triggered, the electronic device starts the associated one or more events automatically.

### BACKGROUND

1. Technical Field

Embodiments of the present disclosure relate to object management systems and methods, and more particularly to a system and a method for associating events with objects in an electronic device.

2. Description of Related Art

Electronic devices may respond to user operations by acting on objects stored in the electronic device. In the domain of object-oriented programming, an object is usually a compilation of attributes and behaviors encapsulating an entity in software. For example, if a user opens an SMS message in an electronic device, contents of the SMS message are shown to the user on a display of the electronic device. However, if the user wants to play music when reading the SMS message, or receive alerts before deleting certain files stored in the electronic device, the user may often find that these options are not possible because the electronic device is not customizable enough.

### BRIEF DESCRIPTION OF THE DRAWINGS

FIG. 1 is a block diagram of one embodiment of an electronic device comprising an association system.

FIG. 2 is a block diagram of one embodiment of the function modules of the association system in FIG. 1.

FIG. 3 is a flowchart illustrating one embodiment of a method for associating events with objects in an electronic device.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

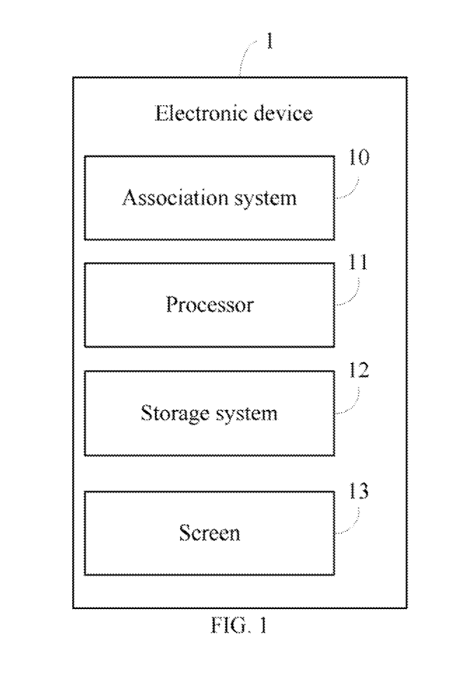

FIG. 1 is a block diagram of one embodiment of an electronic device 1 comprising an association system 10. In some embodiments, the electronic device 1 may be a mobile phone or a tablet personal computer, for example. The electronic device 1 includes a display 13. In one embodiment, the display 13 may be a touch display.

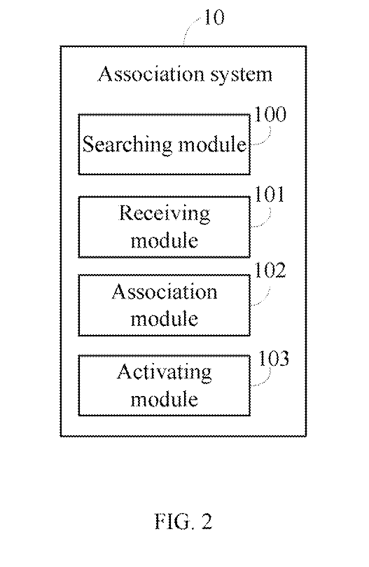

In an exemplary embodiment, the electronic device 1 includes at least one processor 11 and a storage system 12. The association system 10 may include one or more modules (as in FIG. 2). The one or more modules may comprise computerized code in the form of one or more software programs that are stored in the storage system 12 (or memory). In one embodiment, the storage system 12 may be a magnetic or an optical storage system, such as a flash memory, or other suitable storage medium. The computerized code includes instructions that are executed by the at least one processor 11 to provide functions for the one or more modules described below.

The storage system 12 stores objects, such as short message service (SMS) messages, pictures, a phone book, music, or videos which can be operated by users. The storage system 12 also stores attributes of the objects. Attributes of each object include operation behaviors and an identifier of the object. The operation behaviors describe the methods in the object's interface by which the object can be used. For example, the operation behaviors of an SMS message or a picture may include opening, editing, and deleting the SMS message or the picture. The operation behaviors of the phone book may include searching for a telephone number in the phone book, deleting a contact, adding a new contact, and dialing a particular telephone number, for example.

The association system 10 associates events with the objects, and initiates an event when an associated object is triggered by a user of the electronic device. The actions of a user are events which are external to the programs of the objects. In this embodiment, the events are defined as that the user may wish to see when starting the operation behaviors of the objects. For example, the desired event may be playing music, playing back a video, starting a vibrating mode of the electronic device 1, or displaying pictures. If the association system 10 associates the playing of music with the opening of a user-selected SMS message, music will be played if the user-selected SMS message is opened.

As shown in FIG. 2, the triggering system 10 may include a searching module 100, a receiving module 101, a storing module 102, and an activating module 103.

The searching module 100 receives keywords input by a user, and searches for all objects which relate to the keywords. In one embodiment, the user may input the keywords by touching the display 13 of the electronic device 1.

The receiving module 101 receives an object selected from all objects which are displayed on the display 13, and receives an operation behavior selected from all the attributes which are displayed on the display 13 of the object. The receiving module 101 further receives one or more events selected by the user according to his requirements.

The association module 102 associates the selected one or more events with the selected operation behavior of the objects, stores the associated one or more events and the selected operation behavior into the attributes of the object, and stores the attributes which include the associated one or more events and the operation behavior of the object to the storage system 12.

The activating module 103 starts the associated one or more events as a response to the selected operation behavior of the object being initiated by the user.

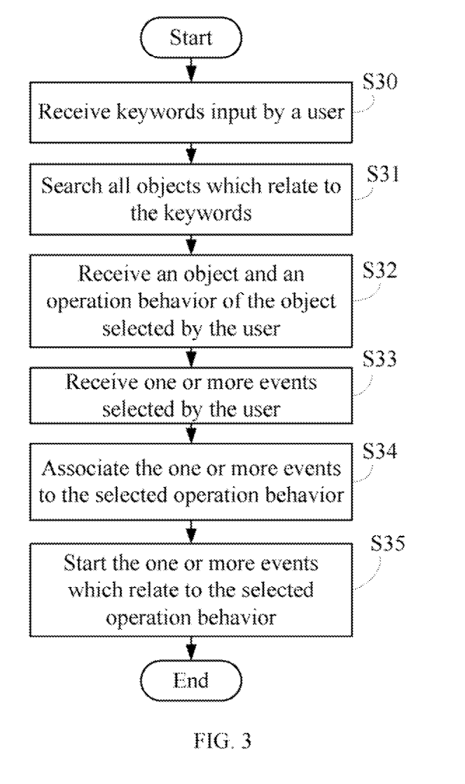

FIG. 3 is a flowchart illustrating a method for associating events with objects in an electronic device. Depending on the embodiment, additional blocks may be added, others removed, and the ordering of the blocks may be changed.

In block S30, the searching module 100 receives keywords input by a user.

In block S31, the searching module 100 searches through all objects which may relate to the keywords. For example, the user may input the keywords “Mr. Li” by using the display 13 of the electronic device 1. The searching module 100 searches all objects which relate to “Mr. Li.” The result of the searching may include any SMS messages sent from “Mr. Li,” and a contact phone number of “Mr. Li.”

In block S32, the receiving module 101 receives an object selected by the user, and receives an operation behavior selected by the user from the attributes of the object. In one embodiment, the user might select SMS messages sent from “Mr. Li” and the opening of the SMS messages as the particular operation behavior.

In block S33, the receiving module 101 receives one or more events selected by the user according to his requirement. The receiving module 101 may receive the playing of music as an event.

In block S34, the association module 102 associates the selected one or more events with the selected operation behavior of the objects, stores the one or more events as being associated with the selected operation behavior into the attributes of the object, and stores the attributes of the object to the storage system 12.

In block S35, if the selected operation behavior of the object is started by the user, the activating module 103 starts the associated one or more events which relate to the selected operation behavior. If for example the SMS messages of “Mr. Li” are opened, music will start to play, to the greater satisfaction of the user.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor; and
one or more programs being stored in the storage system and executable by the at least one processor, the one or more programs comprising:
a receiving module operable to receive a user-selected operation behavior selected from attributes of an object of the electronic device displayed on the display and user-selected one or more events displayed on the display;
an association module operable to associate the one or more events with the user-selected operation behavior of the object, and store the associated one or more events and the user-selected operation behavior into the attributes of the object; and
an activating module operable to start the associated one or more events if the selected operation behavior of the object is initiated in response to an operation activated by the user.

2. The electronic device as described in claim 1, wherein the one or more programs further comprises: a searching module operable to receive keywords input by a user.

3. The electronic device as described in claim 2, wherein the searching module is further operable to search all objects of the electronic device which relate to the keywords.

4. The electronic device as described in claim 1, wherein the objects comprise short message service (SMS) messages, pictures, a phone book, and videos.

5. A computer-based method for triggering events of objects of an electronic device comprising a display, the method comprising:
receiving a user-selected operation behavior selected from attributes of an object of the electronic device displayed on the display and user-selected one or more events displayed on the display;
associating the one or more events with the user-selected operation behavior of the object, and storing the associated one or more events and the user-selected operation behavior into attributes of the object; and
starting the associated one or more events if the selected operation behavior of the object is initiated in response to an operation activated by a user.

6. The method as described in claim 5, further comprising:
receiving keywords input by the user; and
searching all objects of the electronic device which relate to the keywords.

7. The method as described in claim 5, wherein the objects comprises short message service (SMS) messages, pictures, a phone book, and videos.

8. A non-transitory storage medium having stored thereon instructions that, when executed by a processor, cause the processor to perform a method for triggering events of objects of an electronic device, the method comprising:
receiving a user-selected operation behavior selected from attributes of an object of the electronic device displayed on a display and user-selected one or more events displayed on the display;
associating the one or more events with the user-selected operation behavior of the object, and storing the associated one or more events and the user-selected operation behavior into attributes of the object; and
starting the associated one or more events if the selected operation behavior of the object is initiated in response to an operation activated by a user.

9. The non-transitory storage medium as described in claim 8, further comprising:
receiving keywords input by the user; and
searching all objects of the electronic device which relates to the keywords.

10. The non-transitory storage medium as described in claim 8, wherein the objects comprises short message service (SMS) messages, pictures, a phone book, and videos.
